(19) United States
(12) Patent Application Publication
(10) Pub. No.: US 2010/0259528 A1
(43) Pub. Date: Oct. 14, 2010

(54) Dynamic Adaptation of the Power Supply Voltage for Current-Driven EL Displays

(75) Inventors: Euan C. Smith, Cambridgeshire (GB); Richard Alan Page, Mountain View, CA (US); Stefan Wurster, Livermore, CA (US); Barry Thompson, Menlo Park, CA (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: CAMBRIDGE DISPLAY TECHNOLOGY LIMITED, Cambridgeshire (GB)

(21) Appl. No.: 12/680,122

(22) PCT Filed: Sep. 26, 2008
(86) PCT No.: PCT/GB2008/003293

§ 371 Date: Jun. 9, 2010

(30) Foreign Application Priority Data
Oct. 5, 2007 (GB) 0719512.6

(51) Int. Cl. G06F 3/038

(52) U.S. Cl. 345/212; 345/76

(57) ABSTRACT

A display driver control circuitry and method for controlling a display driver for an electroluminescent display, the display comprising at least one substantially constant current generator for driving the display element, the control circuitry comprising: a drive voltage sensor for sensing a drive voltage on a first line in which the current is regulated by the constant current generator; a reference voltage generator for providing a reference voltage offset from a supply voltage provided from a supply line to the constant current generator; means for determining a difference between the reference voltage and the drive voltage and for generating an adjustment signal, and wherein a voltage controller is configured to adjust the supply voltage responsive to the adjustment signal.

Organic light emitting diodes (OLEDs) comprise a particularly advantageous form of electro-optic display. They are bright, colourful, fast switching, provide a wide viewing angle and are easy and cheap to fabricate on a variety of substrates.

Organic (which here includes organometallic) LEDs may be fabricated using either polymers or small molecules in a range of colours, depending upon the materials used. Examples of polymer-based organic LEDs are described in WO 90/13148, WO 95/06400 and WO 99/48160; examples of small molecule based devices are described in U.S. Pat. No. 4,539,507 and examples of dendrimer-based materials are described in WO 99/21935 and WO 02/067343.

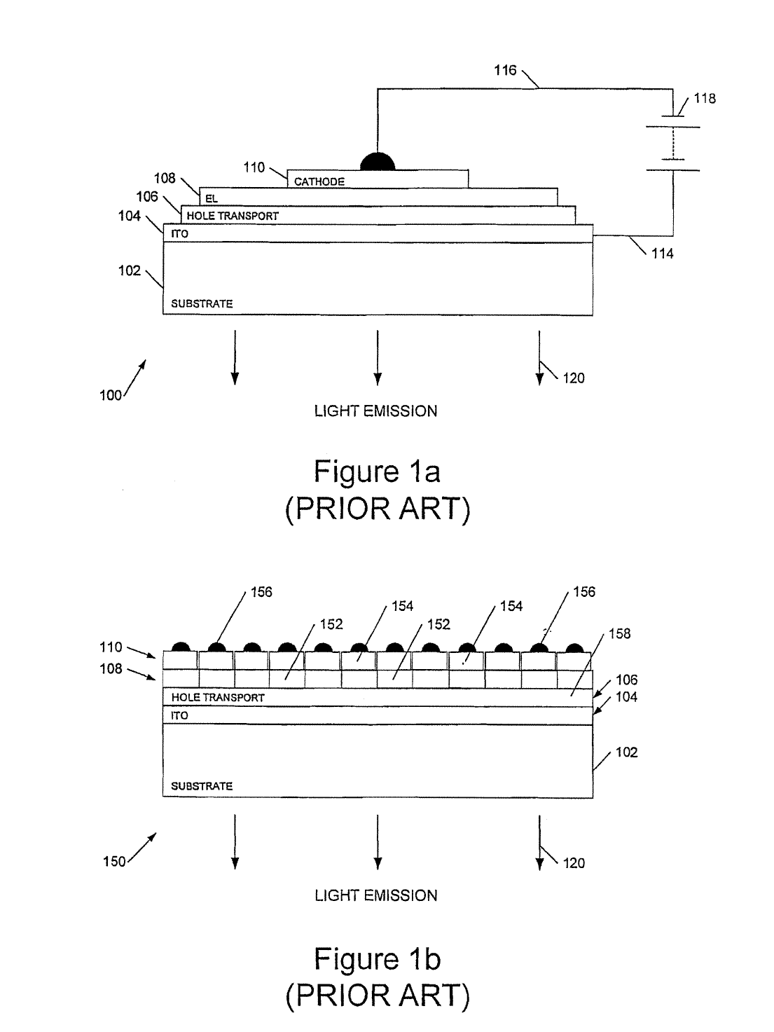

A basic structure 100 of a typical organic LED is shown in FIG. 1a. A glass or plastic substrate 102 supports a transparent anode layer 104 comprising, for example, indium tin oxide (ITO) on which is deposited a hole transport layer 106, an electroluminescent layer 108 and a cathode 110. The electroluminescent layer 108, may comprise, for example, PEDOT: PSS (polystyrene-sulphorate—doped polyethylene—dioxythiophene). Cathode layer 110 typically comprises a low work function metal such as calcium and may include an additional layer immediately adjacent electroluminescent layer 108, such as a layer of aluminium, for improved electron energy level matching. Contact wires 114 and 116 to the anode and the cathode respectively provide a connection to a power source 118. The same basic structure may also be employed for small molecule devices.

In the example shown in FIG. 1a light 120 is emitted through transparent anode 104 and substrate 102 and such devices are referred to as “bottom emitters”. Devices which emit through the cathode may also be constructed, for example, by keeping the thickness of cathode layer 110 less than around 50-100 mm so that the cathode is substantially transparent.

Organic LEDs may be deposited on a substrate in a matrix of pixels to form a single or multi-colour pixellated display. A multi-coloured display may be constructed using groups of red, green and blue emitting pixels. In such displays the individual elements are generally addressed by activating row (or column) lines to select the pixels, and rows (or columns) of pixels are written to, to create a display. So-called active matrix displays have a memory element, typically a storage capacitor and a transistor, associated with each pixel whilst passive matrix displays have no such memory element and instead are repetitively scanned, somewhat similarly to a TV picture, to give the impression of a steady image.

FIG. 1b shows a cross-section through a passive matrix OLED display 150 in which like elements to those of FIG. 1a are indicated by like reference numerals. In the passive matrix display 150 the electroluminescent layer 108 comprises a plurality of pixels 152 and the cathode layer 110 comprises a plurality of mutually electrically insulated conductive lines 154, running into the page in FIG. 1b, each with an associated contact 156. Likewise the ITO anode layer 104 also comprises a plurality of anode lines 158, of which only one is shown in FIG. 1b, running at right angles to the cathode lines. Contacts (not shown in FIG. 1b) are also provided for each anode line. An electroluminescent pixel 152 at the intersection of a cathode line and anode line may be addressed by applying a voltage between the relevant anode and cathode lines.

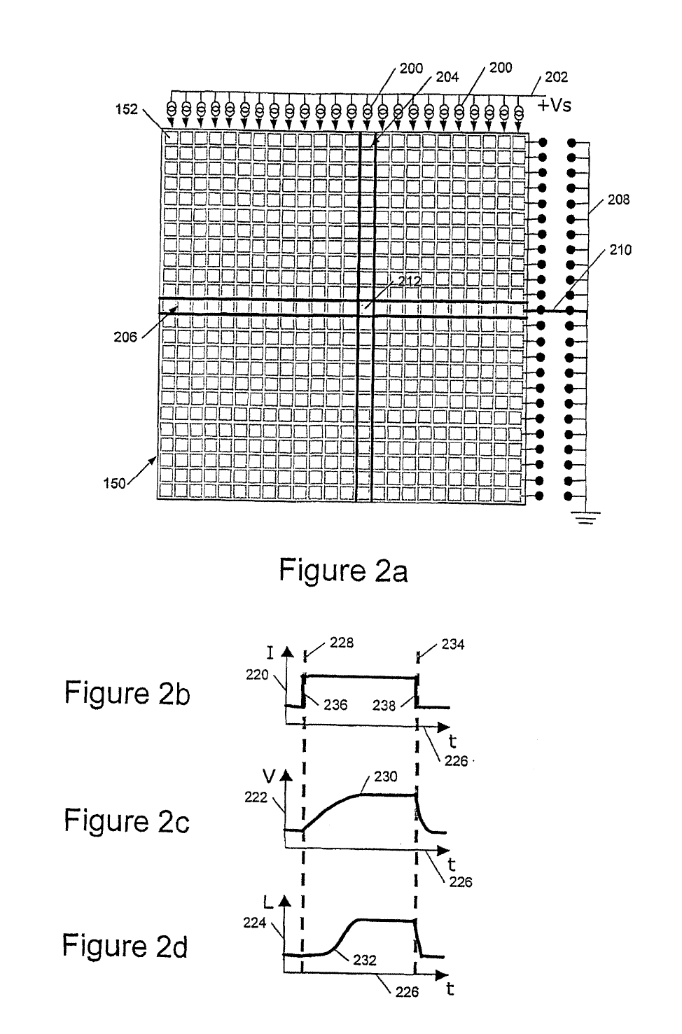

Referring now to FIG. 2a, this shows, conceptually, a driving arrangement for a passive matrix OLED display 150 of the type shown in FIG. 1b. A plurality of constant current generators 200 are provided, each connected to a supply line 202 and to one of a plurality of column lines 204, of which for clarity only one is shown. A plurality of row lines 206 (of which only one is shown) is also provided and each of these may be selectively connected to a ground line 208 by a switched connection 210. As shown, with a positive supply voltage on line 202, column lines 204 comprise anode connections 158 and row lines 206 comprise cathode connections 154, although the connections would be reversed if the power supply line 202 was negative with respect to ground line 208.

As illustrated pixel 212 of the display has power applied to it and is therefore illuminated. To create an image connection 210 for a row is maintained as each of the column lines is activated in turn until the complete row has been addressed, and then the next row is selected and the process repeated. Alternatively a row may be selected and all the columns written in parallel, that is a row selected and a current driven into each of the column lines simultaneously, to simultaneously illuminate each pixel in a row at its desired brightness. Although the latter arrangement requires more column drive circuitry it is preferred because it allows a more rapid refresh of each pixel. In a further alternative arrangement each pixel in a column may be addressed in turn before the next column is addressed, although this is generally not preferred because of the effect, inter alia, of column capacitance as discussed below. It will be appreciated that in the arrangement of FIG. 2a the functions of the column driver circuitry and row driver circuitry may be exchanged.

It is usual to provide a current-controlled rather than a voltage-controlled drive to an OLED because the brightness of an OLED is determined by the current flowing through it, thus determining the number of photons it outputs. In a voltage-controlled configuration the brightness can vary across the area of a display and with time, temperature, and age, making it difficult to predict how bright a pixel will appear when driven by a given voltage. In a colour display the accuracy of colour representations may also be affected.

FIGS. 2b to 2d illustrate, respectively the current drive 220 applied to a pixel, the voltage 222 across the pixel and the light output 224 from the pixel over time 226 as the pixel is addressed. The row containing the pixel is addressed and at the time indicated by dashed line 228 the current is driven onto the column line for the pixel. The column line (and pixel) has an associated capacitance and thus the voltage gradually rises to a maximum 230. The pixel does not begin to emit light until a point 232 is reached where the voltage across the pixel is greater than the OLED diode voltage drop. Similarly when the drive current is turned off at time 234 the voltage and light output gradually decay as the column capacitance discharges. Where the pixels in a row are all written simultaneously, that is where the columns are driven in parallel, the time interval between times 228 and 234 corresponds to a line scan period.

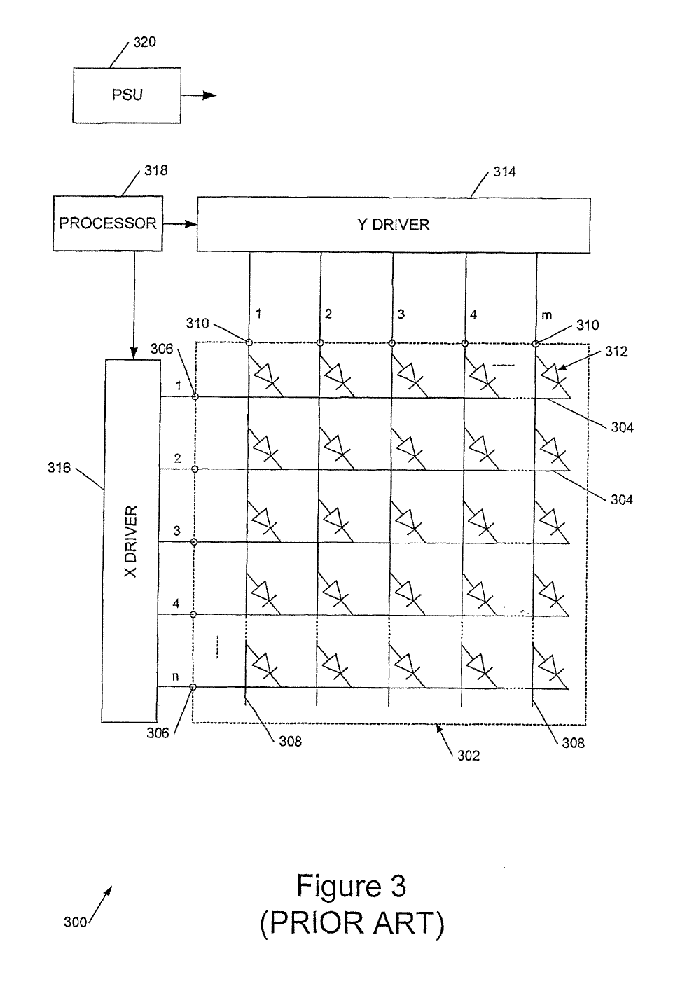

FIG. 3 shows a schematic diagram 300 of a generic driver circuit for a passive matrix OLED display. The OLED display is indicated by dashed line 302 and comprises a plurality n of row lines 304 each with a corresponding row electrode contact 308 and a plurality n of column lines 308 with a corresponding plurality of column electrode contacts 310. An OLED is connected between each pair of row and column lines with, in the illustrated arrangement, its anode connected to the column line. A y-driver 314 drives the column lines 308 with a constant current and an x-driver 316 drives the row lines 304, selectively connecting the row lines to ground. The y-driver 314 and x-driver 316 are typically both under the control of a processor 318. A power supply 320 provides power to the circuitry and, in particular, to y-driver 314.

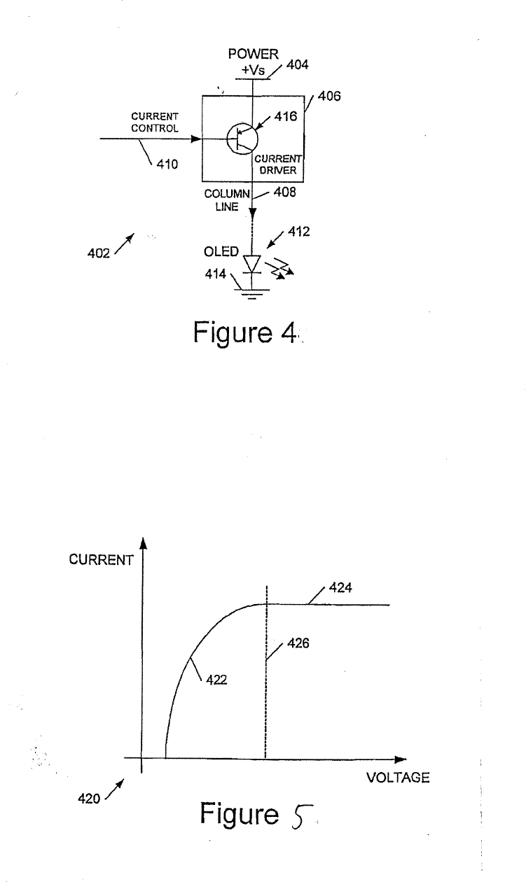

FIG. 4 shows schematically the main features of a current driver 402 for one column line of a passive matrix OLED display, such as the display 302 of FIG. 3. Typically a plurality of such current drivers are provided in a column driver integrated circuit, such as y-driver 314 of FIG. 3, for driving a plurality of passive matrix display column electrodes.

The current driver 402 of FIG. 4 outlines the main features of this circuit and comprises a current driver block 406 incorporating a bipolar transistor 416 which has an emitter terminal substantially directly connected to a power supply line 404 at supply voltage Vs. (This does not necessarily require that the emitter terminal should be connected to a power supply line or terminal for the driver by the most direct route but rather that there should preferably be no intervening components, apart from the intrinsic resistance of tracks or connections within the driver circuitry between the emitter and a power supply rail). A column drive output 408 provides a current drive to OLED 412, which also has a ground connection 414, normally via a row driver MOS switch (not shown in FIG. 4). A current control input 410 is provided to current driver block 406 and, for the purpose of illustration, this is shown connected to the base of transistor 416 although in practice a current mirror arrangement is preferred. The signal on current control line 410 may comprise either a voltage or a current signal. Where the current driver block 406 provides a variable controllable current source each current driver block may be interfaced with and controlled by an analogue output from a digital to analogue converter. Such a controllable current source can provide a variable brightness or grayscale display. Other methods of varying pixel brightness include varying pixel on time using Pulse Width Modulation (PWM). In a PWM scheme a pixel is either fully on or completely off but the apparent brightness of a pixel varies because of time integration within the observer's eye.

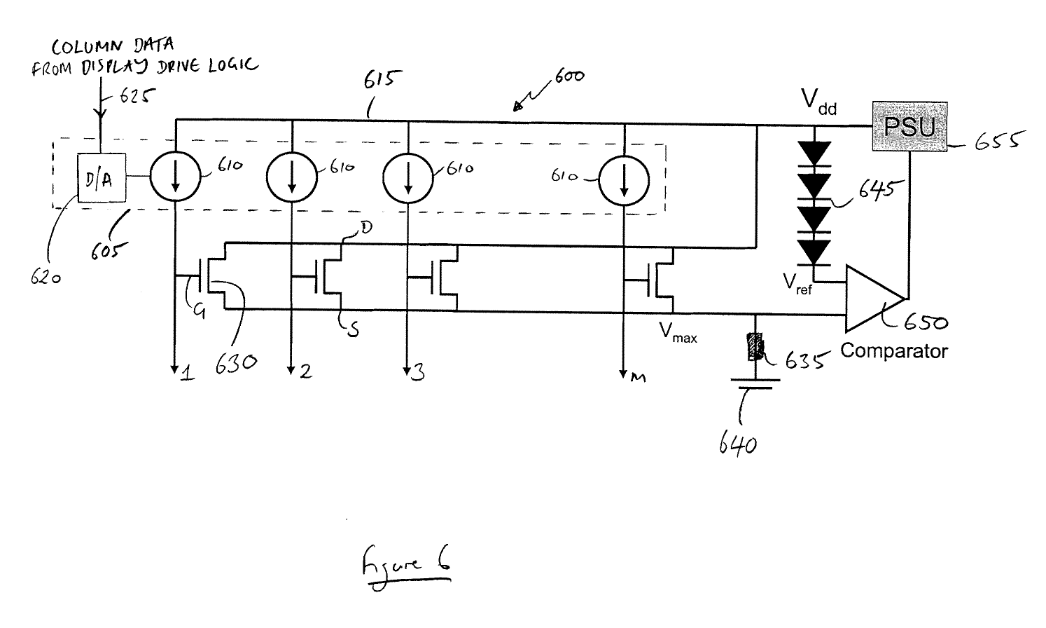

Referring to FIG. 5, a graph 420 of current drawn from a power supply against a power supply voltage is illustrated for an OLED driven from a controllable constant current source. This curve has an initial “dead” region in which substantially no current flows until the forward voltage is sufficient to turn the OLED on. A non-linear region 422 is then followed by a substantially flat portion 424 of the curve above a voltage indicated by a dashed line 426, giving a generally “S” shaped curve. At the voltage indicated by dashed line 426, a minimum supply voltage is defined to ensure that the constant current source is well behaved at the current it is controlled to provide.

As can be readily seen from FIG. 5, there exists a region 424 where increasing the power merely increases power dissipation. It is therefore preferable to operate at or close to the voltage indicated by dashed line 426. However, the power supply voltage for this limit depends upon a number of factors which include display age, display temperature and where a variable current is supplied upon the current being provided by the constant current source. There is therefore a continuing need for techniques which can adapt power supply voltage control to changing environment or driving conditions.

According to a first aspect of the present invention, there is provided a display driver control circuitry for controlling a display driver for an electroluminescent display, the display comprising at least one substantially constant current generator for driving the display element, the control circuitry comprising: a drive voltage sensor for sensing a drive voltage on a first line in which the current is regulated by the constant current generator; a reference voltage generator for providing a reference voltage offset from a supply voltage provided from a supply line to the constant current generator; means for determining a difference between the reference voltage and the drive voltage and for generating an adjustment signal, and wherein a voltage controller is configured to adjust the supply voltage responsive to the adjustment signal.

Preferably, the display is a passive matrix display having a plurality of electroluminescent display elements and a plurality of substantially constant current generators, wherein the drive voltage sensor is configured to sense a maximum voltage and the means for determining is a comparator configured to determine a difference between the reference voltage and the maximum voltage.

More preferably, the drive voltage sensor comprises a plurality of transistors each having a gate connection to a line in which the current is regulated by the constant current generator, and wherein each source terminal of the plurality of transistors is connected together to the supply line and each drain terminal of the plurality of transistors is connected together to a further line.

Preferably, the transistors are n-channel field effect transistors and optionally the further line is at ground potential or potential below the supply voltage.

Preferably, the reference voltage generator comprises a number of junction voltages and the voltage controller preferably comprises a dc to dc converter.

Whilst the first aspect of the present invention is compatible with general passive matrix driving schemes, the circuitry is preferably configured for multi-line addressing and the luminescence of an electroluminescent element is obtainable by a substantially linear sum of successive drive signals to the element.

According to a second aspect of the present invention, there is provided a method of regulating a power supply voltage of a display driver driving an electroluminescent display, the display comprising at least one electroluminescent display element, the driver including at least one substantially constant current generator for driving the display element and having a power supply line for supplying the power supply voltage for the current generator, the method comprising: sensing a drive voltage offset from the supply voltage; determining a difference between the reference voltage and the drive voltage and generating an adjustment signal; controlling the supply voltage responsive to the adjustment signal.

Preferably, the display is a passive matrix display having a plurality of electroluminescent display elements and a plurality of substantially constant current generators and wherein sensing a drive voltage comprises sensing a maximum voltage and the determining comprises determining a difference between the reference voltage and the maximum voltage.

Whilst the second aspect of the present invention is compatible with general passive matrix driving schemes, the method is preferably configured for multi-line addressing such that the passive matrix display comprises an array of rows and columns electrodes and the method of driving the display comprises driving a plurality of column electrodes at the same time as driving two or more row electrodes. More preferably, the desired luminescence of the electroluminescent element is obtainable by a substantially linear sum of successive drive signals to the pixel.

Preferably the step of controlling includes one of increasing the supply voltage or decreasing the supply voltage as appropriate and increasing the supply voltage is performed more rapidly than decreasing the supply voltage.

There is also a continuing need for techniques which can improve the lifetime of an OLED display. There is a particular need for techniques which are applicable to passive matrix displays since these are very much cheaper to fabricate than active matrix displays. Reducing the drive level (and hence brightness) of an OLED can significantly enhance the lifetime of the device—for example halving the drive/brightness of the OLED can increase its lifetime by approximately a factor of four. In applications, WO 2006 035246, WO 2006 035247 and WO 2006 035248, the contents of which are herein incorporated by reference, the applicant has recognised that one solution lies in multi-line addressing techniques employed to reduce peak display drive levels, in particular in passive matrix OLED displays, and hence increase display lifetime. Broadly speaking, these methods comprise driving a plurality of column electrodes of the OLED display with a first set of column drive signals at the same time as driving two or more row electrodes of the display with a first set of row drive signals; then the column electrodes are driven with a second set of column drive signals at the same time as the two or more row electrodes are driven with a second set of row drive signals. Preferably the row and column drive signals comprise current drive signals from a substantially constant current generator such as a current source or current sink. Preferably such a current generator is controllable or programmable, for example, using a digital-to-analogue converter.

The effect of driving a column at the same time as two or more rows is to divide the column drive between two or more rows in a proportion determined by the row drive signals—in other words for a current drive the current in a column is divided between the two or more rows in proportions determined by the relative values or proportions of the row drive signals. Broadly speaking this allows the luminescence profile of a row or line of pixels to be built up over multiple line scan period, thus effectively reducing the peak brightness of an OLED pixel thus increasing the lifetime of pixels of the display. With a current drive a desired luminescence of a pixel is obtained by means of a substantially linear sum of successive drive signals to the pixel.

The present invention is therefore concerned with improving the efficiency of, in particular, a passive matrix OLED display. Advantageously, the present invention is also compatible with multi-line addressing techniques.

These and further embodiments of the invention will now be described, by way of example only, and with reference to the accompanying figures in which:

FIGS. 1a and 1b show cross sections through, respectively, an organic light emitting diode and a passive matrix OLED display;

FIGS. 2a and 2d show, respectively, a conceptual driver arrangement for a passive matrix OLED display, a graph of current drive against time for a display pixel, a graph of pixel voltage against time, and a graph of pixel light output against time;

FIG. 3 shows a schematic diagram of a generic driver circuit for a passive matrix OLED display according to the prior art;

FIG. 4 shows a current driver for a column of a passive matrix OLED display;

FIG. 5 shows a current-voltage curve for an OLED display element and its associated current source; and

FIG. 6 shows a portion of a schematic diagram of a passive matrix OLED driver circuitry according to a first embodiment of the present invention.

Thus, FIG. 6 shows a portion of a schematic diagram of a passive matrix OLED display 600 according to a first embodiment of the present invention. The display 600 comprises row electrodes driven by row driver circuits (not shown in FIG. 6) and column electrodes lines 1, 2, 3 . . . m driven by column driver 605. The driver for each column comprises a substantially constant current generator 610 (as illustrated by a current source) such as that described in FIG. 4. In FIG. 6, each current generator 610 is powered by a power supply voltage V_{dd} on supply line 615 and is controlled by an analogue output from a digital to analogue converter 620. A control input 625 is provided to the digital to analogue converter 620 from a display drive logic for providing display data to the column drivers 610. The display drive logic may also provide row select control to the row drivers (not shown). A digital to analogue converter 610 may be provided for each column electrode line 1, 2, 3 . . . m or a single digital to analogue converter may be shared between the column lines, for example by time multiplexing.

As drawn in FIG. 6, the current source is a controllable current source to provide a variable brightness or greyscale display but in other embodiments fixed current sources may be employed. Pulse width modulation may be used in these embodiments to give the appearance of variable brightness to the human eye, or alternatively, the pixels of the display may all have substantially the same relative brightness, that is the display may not be a greyscale display. In still other embodiments the display may employ pixels of different colours to provide a variable colour display.

Each column electrode line 1, 2, 3 . . . m is connected to a gate terminal G of an n-channel Field Effect Transistor (FET) 630, the source terminals S of which are connected together to a pull-down resistor 635 to ground 640 (or some other voltage below that of the supply voltage). The drain terminals D of the n-channel FETs 630 are connected together to the supply line 615.

A reference voltage source 645 comprises an array of built-in junction voltages and is connected at one end to the supply line 615 and at the other end to a first input terminal of a comparator 650. The comparator 650 has a second input terminal connected to each source terminal of the n-channel field effect transistors 630. An output terminal of the comparator is connected to a voltage controller 655, which is configured to alter the output supply voltage provided to the column drivers 605. Such a voltage controller 655 may comprise a dc to dc controller as is known in the art.

In operation, a power supply voltage V_{dd} takes initially, as an example, a value of 15V and the reference voltage source 645 provides a voltage drop of 3V thereby holding a reference voltage V_{ref} at the first input to the comparator 650 of 12V. A source connection of each FET 630 is provided as a maximum column voltage Vₘₐₓ and should any column electrode line 1, 2, 3 . . . m rise above the maximum column voltage then the gate terminal G of the corresponding FET 630 is pulled up above the source terminal S turning the FET 630 on and pulling the source terminal voltage S up until either the FET 630 turns off or sufficiently for the current of the corresponding FET 630 to match the current sunk through the pull-down resistor 635. The maximum column voltage Vₘₐₓ is compared to the reference voltage V_{ref} by the comparator 650 which generates a single bit signal indicating whether an increase or decrease in power voltage V_{dd} is required. When an increase in power voltage V_{dd} is required the dc to dc controller is operable to increase the power supply voltage rapidly. When a decrease in power voltage V_{dd} is required the dc to dc controller is operable to cause the power supply voltage to gradually decay down. In particular, a rapid increase in power supply voltage can be required due to an increase in display brightness and image content.

No doubt many other effective alternatives will occur to the skilled person. It will be understood that the invention is not limited to the described embodiments and encompasses modifications apparent to those skilled in the art lying within the spirit and scope of the claims appended hereto.

1. A display driver control circuitry for controlling a display driver for an electroluminescent display, the display comprising at least one substantially constant current generator for driving the display element, the control circuitry comprising:
a drive voltage sensor for sensing a drive voltage on a first line in which the current is regulated by the constant current generator;
a reference voltage generator for providing a reference voltage offset from a supply voltage provided from a supply line to the constant current generator; and,
means for determining a difference between the reference voltage and the drive voltage and for generating an adjustment signal, and wherein a voltage controller is configured to adjust the supply voltage responsive to the adjustment signal.

2. A display driver control circuitry according to claim 1, wherein the display is a passive matrix display having a plurality of electroluminescent display elements and a plurality of substantially constant current generators, wherein the drive voltage sensor is configured to sense a maximum voltage and the means for determining is a comparator configured to determine a difference between the reference voltage and the maximum voltage.

3. A display driver control circuitry as claimed in claim 2, wherein the drive voltage sensor comprises a plurality of transistors each having a gate connection to a line in which the current is regulated by the constant current generator, and wherein each source terminal of the plurality of transistors is connected together to the supply line and each drain terminal of the plurality of transistors is connected together to a further line.

4. A display driver control circuitry as claimed in claim 3, wherein the transistors are n-channel field effect transistors.

5. A display driver control circuitry as claimed in claim 3, wherein the further line is at ground potential or potential below the supply voltage.

6. A display driver control circuitry as claimed in claim 1, wherein the reference voltage generator comprises a number of junction voltages.

7. A display driver control circuitry as claimed in claim 1 wherein the voltage controller comprises a dc to dc converter.

8. A display driver control circuitry as claimed in claim 1, wherein the electroluminescent display element comprises an organic light emitting diode.

9. A display driver control circuitry as claimed in claim 2, wherein the passive matrix display comprises an array of rows and columns and the circuitry is configured for multi-line addressing.

10. A display driver circuitry as claimed in claim 9, wherein the luminescence of an electroluminescent element is obtainable by a substantially linear sum of successive drive signals to the element.

11. A method of regulating a power supply voltage of a display driver driving an electroluminescent display, the display comprising at least one electroluminescent display element, the driver including at least one substantially constant current generator for driving the display element and having a power supply line for supplying the power supply voltage for the current generator, the method comprising:
sensing a drive voltage offset from the supply voltage;
determining a difference between the reference voltage and the drive voltage and generating an adjustment signal; and,
controlling the supply voltage responsive to the adjustment signal.

12. A method as claimed in claim 11, wherein the display is a passive matrix display having a plurality of electroluminescent display elements and a plurality of substantially constant current generators and wherein sensing a drive voltage comprises sensing a maximum voltage and the determining comprises determining a difference between the reference voltage and the maximum voltage.

13. A method as claimed in claim 12, wherein the passive matrix display comprises an array of rows and columns electrodes and the method of driving the display comprises driving a plurality of column electrodes at the same time as driving two or more row electrodes.

14. A method as claimed in claim 13, wherein the desired luminescence of the electroluminescent element is obtainable by a substantially linear sum of successive drive signals to the pixel.

15. A method as claimed in claim 11, wherein the electroluminescent element comprises an organic light emitting diode.

16. A method as claimed in claim 11, wherein the step of controlling includes one of increasing the supply voltage or decreasing the supply voltage and increasing the supply voltage is performed more rapidly than decreasing the supply voltage.

17. (canceled)

18. (canceled)
